(19) United States
(12) Patent Application Publication
(10) Pub. No.: US 2014/0087634 A1
(43) Pub. Date: Mar. 27, 2014

(54) SHOT BLASTING SYSTEM AND METHOD OF CONTROLLING THE SAME

(71) Applicant: ASAHI Forge Corporation, Nagoya-City (JP)

(72) Inventor: Sumio ASAHI, Gujo-City (JP)

(73) Assignee: ASAHI FORGE CORPORATION, Nagoya-City (JP)

(21) Appl. No.: 14/089,768

(22) Filed: Nov. 26, 2013

Related U.S. Application Data
(63) Continuation of application No. PCT/JP2012/079899, filed on Nov. 19, 2012.

(30) Foreign Application Priority Data
Apr. 7, 2012 (JP) 2012-087991

(51) Int. Cl. B65G 1/04; B65G 47/52; B24C 9/00

(52) U.S. Cl. CPC B65G 1/04; B24C 9/00; B65G 47/52
USPC 451/38; 451/80

(57) ABSTRACT

A shot blasting system includes an automatic warehouse, a shot blasting equipment, and a traverser. The automatic warehouse is configured to receive and dispatch a pallet with a workpiece housed therein by using a stacker crane. The shot blasting equipment is to perform shot blasting on the workpiece. The traverser is configured to convey the pallet between the automatic warehouse and the shot blasting equipment.

### CROSS-REFERENCE TO RELATED APPLICATIONS

The present application is a continuation application of International Application No. PCT/JP2012/079899, filed Nov. 19, 2012, which claims priority to Japanese Patent Application No. 2012-087991, filed Apr. 7, 2012. The contents of these applications are incorporated herein by reference in their entirety.

### BACKGROUND OF THE INVENTION

1. Field of the Invention

The invention relates to a shot blasting system and a method of controlling the shot blasting system.

2. Discussion of the Background

Conventionally, one such as described in, for example, JP6-63964A has been known as a shot blasting machine that automatically supplies and discharges a workpiece when removing scale and burrs from the workpiece by striking an abrasive such as the steel shot to the workpiece. Such a shot blasting machine can automate a series of operations from supplying via shot blasting to discharging of a workpiece, thereby saving in labor.

### SUMMARY OF THE INVENTION

According to one aspect of the present invention, a shot blasting system includes an automatic warehouse, a shot blasting equipment, and a traverser. The automatic warehouse is configured to receive and dispatch a pallet with a workpiece housed therein by using a stacker crane. The shot blasting equipment is to perform shot blasting on the workpiece. The traverser is configured to convey the pallet between the automatic warehouse and the shot blasting equipment.

According to another aspect of the present invention, in a method of controlling a shot blasting system, a pallet is dispatched with a workpiece housed from a predetermined rack and is conveyed to an electric carriage of a traverser by using a stacker crane. The pallet is conveyed to an entrance-side roller conveyor of a shot blasting equipment by using the motor-operated carriage. The workpiece is thrown from the pallet on the entry-side roller conveyor into a revolving drum. The pallet is conveyed from the entry-side roller conveyor to an exit-side roller conveyor by using the motor-operated carriage. Blasting is performed by striking an abrasive to the workpiece in the revolving drum. The post-blasting workpiece is discharged from the revolving drum to the pallet via a discharge feeder. The pallet is conveyed from the exit-side roller conveyor to the motor-operated carriage. The pallet is conveyed to the stacker crane to house the pallet onto the predetermined rack by using the motor-operated carriage.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a perspective view of a workpiece according to a shot blasting system and a method of controlling the same of an embodiment.

FIGS. 2A and 2B are perspective views of a pallet and a tray according to the shot blasting system and the method of controlling the same of the embodiment.

FIG. 3 is a diagram showing a mechanical configuration according to the shot blasting system and the method of controlling the same of the embodiment.

FIG. 4 is a diagram showing concatenation among an automatic warehouse, a traverser, and a shot blasting equipment according to the shot blasting system and the method of controlling the same of the embodiment.

FIG. 5 is a diagram showing an electric configuration according to the shot blasting system and the method of controlling the same of the embodiment.

FIG. 6 is a flowchart of a pallet conveyance program according to the shot blasting system and the method of controlling the same of the embodiment.

FIG. 7 is a view showing an initial phase of discharging the workpiece to the pallet according to the shot blasting system and the method of controlling the same of the embodiment.

FIG. 8 is a view showing a mid-course phase of discharging the workpiece to the pallet according to the shot blasting system and the method of controlling the same of the embodiment.

FIG. 9 is a view showing a final phase of discharging the workpiece to the pallet according to the shot blasting system and the method of controlling the same of the embodiment.

FIG. 10 is a flowchart of a blasting program according to the shot blasting system and the method of controlling the same of the embodiment.

### DESCRIPTION OF THE EMBODIMENTS

The embodiments will now be described with reference to the accompanying drawings, wherein like reference numerals designate corresponding or identical elements throughout the various drawings.

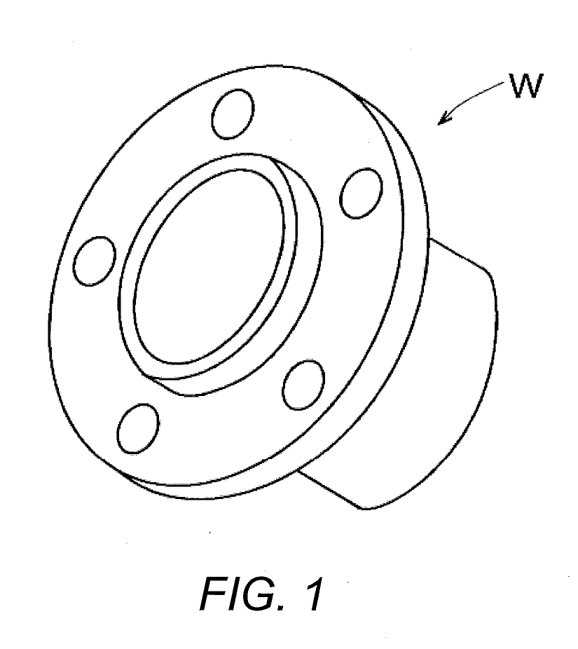

FIG. 1 is a perspective view of a workpiece W handled in the method of controlling the shot blasting system. The workpiece W is obtained by hot forging and undergoes removal of scale and burrs on the surface thereof by the method of controlling the shot blasting system. Although a hot forged product is used as an example of the workpiece W in this embodiment, any other product, for example, a cold forged product may be used.

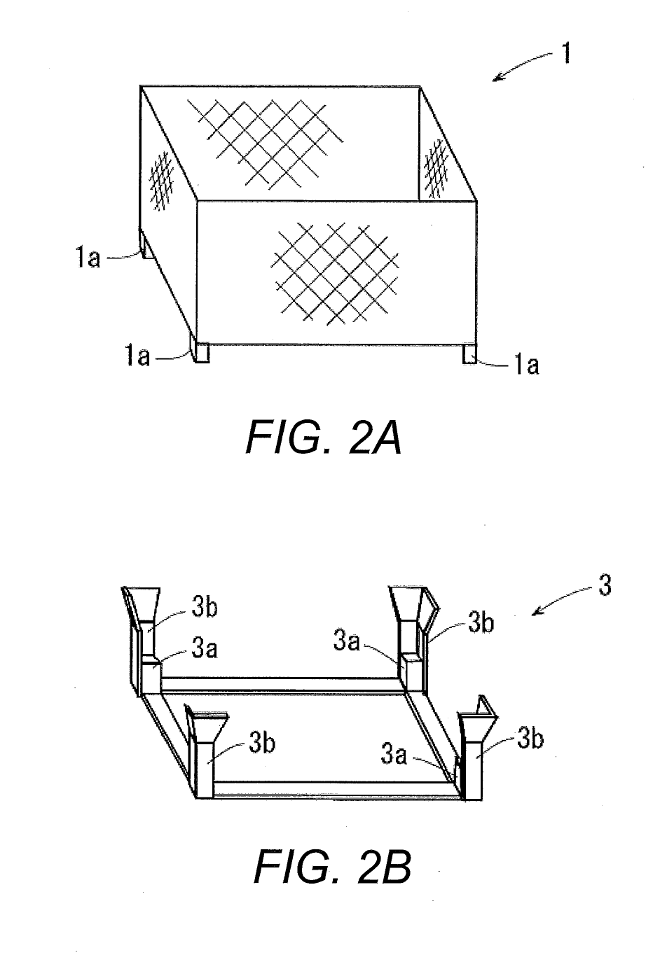

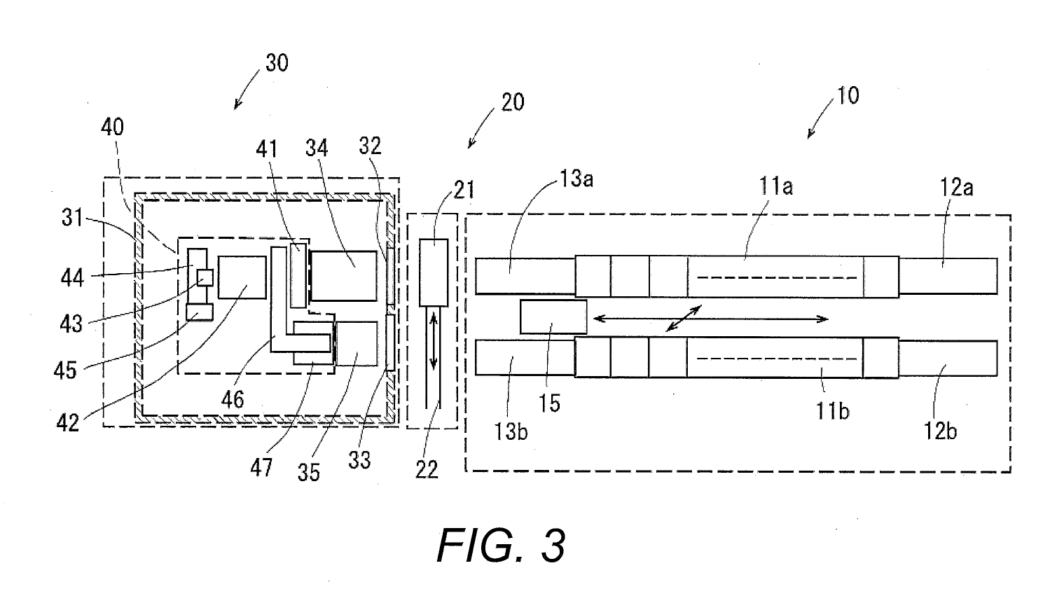

FIGS. 2A and 2B are perspective views of a pallet 1 and a tray 3. The pallet 1 is configured to house a plurality of the workpieces W and used to house them into a later-described automatic warehouse 10 (see FIG. 3) and transport them between the automatic warehouse 10 and a later-described shot blasting equipment 30 (see FIG. 3). The tray 3 is configured to place the pallet 1 thereon and used to transport the tray between the automatic warehouse 10 and the shot blasting equipment 30. The pallet 1 has a rectangular parallelepiped shape with 12 sides formed with a metal rod, four side surfaces and a bottom surface covered by a metal mesh, and an upper surface opened to take in and out the workpiece W. Further, a leg 1a projects downward at each of four corners of the bottom surface. The tray 3 has a square shape with four sides formed with a metal plate. A rectangular parallelepiped block 3a erects at each of four corners of the tray 3. An L-shaped sectional guide plate 3b with a tip extending outward erects on each of two external side surfaces of each of the four blocks 3a in close contact with the block.

The guide plate 3b guides the leg 1a of the pallet 1 to stably place the pallet 1 on the tray 3. The block 3a is used to place the leg 1a of the pallet 1 thereon. By thus providing the blocks 3a, it is possible to shorten the legs 1a of the pallet 1, thereby reducing time for disposing goods by use of the later-described stacker crane 15 (see FIG. 3) and reducing possibilities of the pallet 1 being hooked by the tray 3. The pallet 1 is provided with the four legs 1a in order to insert a fork of the stacker crane 15 between the bottom surface of the pallet 1 and a floor surface. The bottom surface of the tray 3 has the square shape with the four metal plates in order to easily handle the pallet 1 by using a traverser 20 and the shot blasting equipment 30.

FIG. 3 is a mechanical configuration diagram of the shot blasting system. The shot blasting system includes the automatic warehouse 10, the traverser 20, and the shot blasting equipment 30. The automatic warehouse 10 is configured to manage and receive the pallet 1 with a plurality of the workpieces W housed therein, and has a first rack 11a, a second rack lib, a first moving station 12a, a second moving station 12b, a first chain conveyor 13a, and a second chain conveyor 13b, and the stacker crane 15.

The first rack 11a and the second rack 11b are each made up of a plurality of shelves configured to house the pallet 1. In the present embodiment, the first rack 11a and the second rack 11b are each made up of a total of the 90 shelves: horizontal 15 rows (in the right-and-left direction of the paper) times vertical six columns (in the up-and-down direction of the paper in FIG. 3).

The first moving station 12a and the second moving station 12b are used to receive and dispatch the pallet 1 between an outside and each of the first rack 11a and the second rack 11b. To receive the pallet 1 from the outside to the first rack 11a or to the second rack 11b, first the pallet 1 is placed on the external end of the first moving station 12a or the second moving station 12b respectively. Then, the pallet 1 is transported to the opposite end (on the side of the first rack 11a or the second rack 11b) of the first moving station 12a or the second moving station 12b respectively. Then, the pallet 1 is housed in a predetermined one of the shelves of the first rack 11a or the second rack 11b by using the stacker crane 15.

To dispatch the pallet 1 to the outside from the first rack 11a or the second rack 11b, first the pallet 1 is take out by the stacker crane 15 from a predetermined shelf of the first rack 11a or the second rack 11b and is placed on the end of the first rack 11a or the second rack 11b of the first moving station 12a or the second moving station 12b, respectively. Then, the pallet 1 is transported to the opposite side (external side) of the first moving station 12a or the second moving station 12b. Then, the pallet 1 is conveyed to the outside from the first moving station 12a or the second moving station 12b.

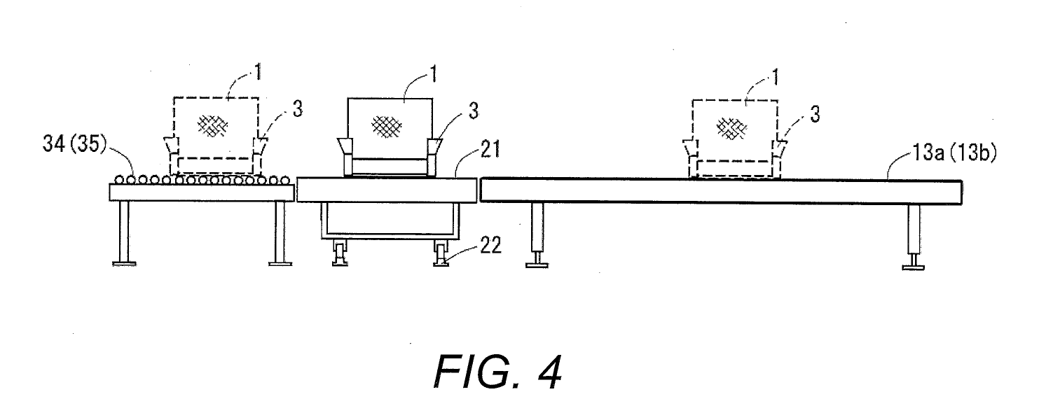

The first chain conveyor 13a and the second chain conveyor 13b are used to receive and dispatch the pallet 1 between the later-described motor-operated carriage 21 of the traverser 20 and each of the first rack 11a and the second rack 11b. To dispatch the pallet 1 to the motor-operated carriage 21 from the first rack 11a or the second rack 11b, first the pallet 1 is taken out from the predetermined shelf of the first rack 11a or the second rack 11b by the stacker crane 15 and is placed on the end of the first rack 11a or the second rack 11b of the first chain conveyor 13a or the second chain conveyor 13b, respectively. At this time, the pallet 1 is placed on the tray 3 that is on the first chain conveyor 13a or the second chain conveyor 13b. Then, as shown also in FIG. 4, the pallet 1 is transported along with the tray 3 to the opposite end (the side of the traverser 20) of the first chain conveyor 13a or the second chain conveyor 13b. Then, the pallet 1 is placed along with the tray 3 on the motor-operated carriage 21 from the first chain conveyor 13a or the second chain conveyor 13b.

In such a manner, the pallet 1 is conveyed along with the tray 3 in a set from the first chain conveyor 13a or the second chain conveyor 13b of the automatic warehouse 10 to the shot blasting equipment 30 via the traverser 20. In the one shot blasting equipment 30, up to two sets of the pallet 1 and the tray 3 can be conveyed simultaneously. In contrast, a great number of (up to 180) pallets 1 can be housed using the first track 11a or the second track 11b of the automatic warehouse 10. Therefore, as in the case of the present embodiment, the pallet 1 and the tray 3 can be separated from each other to reduce the number of the necessary trays, thereby reducing the costs of manufacturing the system as a whole.

To receive the pallet 1 from the motor-operated carriage 21 of the traverser 20 to the first rack 11a or the second rack 11b, first the pallet 1 is placed along with the tray 3 from the motor-operated carriage 21 on the end of the first chain conveyor 13a or the second chain conveyor 13b on the side of the traverser 20, respectively. Then, the pallet 1 is transported along with the tray 3 to the opposite end (the side of the first rack 11a or the second rack 11b) of the first chain conveyor 13a or the second chain conveyor 13b respectively. Then, the pallet 1 is separated from the tray 3 by the stacker crane 15 and housed on the predetermined shelf of the first rack 11a or the second rack 11b.

As shown by an arrow in FIG. 3, the stacker crane 15 can travel in the right-and-left direction of the paper (horizontally between the first rack 11a and the second rack 11b) and in the back-and-forth direction of the paper (up-and-down direction) and is used to receive and dispatch the pallet 1 between the outside and the first rack 11a or the second rack 11b and between the motor-operated carriage 21 of the traverser 20 and the first rack 11a or the second rack 11b.

The traverser 20 has the motor-operated carriage 21 that travels on a track 22 as shown by an arrow in FIG. 3. The motor-operated carriage 21 is used to convey the pallet 1 between the automatic warehouse 10 and the shot blasting equipment 30.

The shot blasting equipment 30 is configured to perform shot blasting on the workpiece W, and has a sound barrier 31, an entry-side roller conveyor 34 surrounded by the sound barrier 31, an exit-side roller conveyor 35, and a shot blasting machine 40. The sound barrier 31 includes an entry-side door 32 and an exit-side door 33.

The sound barrier 31 prevents internal noise from leaking out. The entry-side roller conveyor 34 receives the pallet 1 along with the tray 3 from the motor-operated carriage 21 and hands them to the shot blasting machine 40. The exit-side roller conveyor 35 receives the pallet 1 along with the tray 3 from the shot blasting machine 40 and hands them to the motor-operated carriage 21. Further, the entry-side door 32 and the exit-side door 33 are opened for taking the pallet 1 along with the tray 3 into the inside of the sound barrier 31 and for taking out to the outside respectively. The entry-side door 32 and the exit-side door 33 are both an “automatic door”.

The shot blasting machine 40 has a bucket loader 41, a revolving drum 42, an impeller unit 43, a shot circulator 44, a dust collector 45, a discharge feeder 46, and a tilting device 47. The bucket loader 41 is used to place the pallet 1 along with the tray 3 from the entry-side roller conveyor 34 on a bucket (not shown) in order to throw the workpiece W into the revolving drum 42. The revolving drum 42 stirs the workpiece W and the abrasive to remove scale and burrs from the workpiece W. The impeller unit 43 serves to throw the abrasive into the revolving drum 42. The shot circulator 44 recovers the thrown abrasive and circulates the abrasive to the impeller unit 43 again. The dust collector 45 is a device to suck in dust such as the scale removed from the workpiece W.

When the pallet 1 is carried in the shot blasting equipment 30 from the motor-operated carriage 21 of the traverser 20, first the motor-operated carriage 21 is moved to the entry-side roller conveyor 34 as shown in FIG. 4 also. Then, the entry-side door 32 is opened to place the pallet 1 along with the tray 3 from the motor-operated carriage 21 on the entry-side roller conveyor 34.

When the pallet 1 is carried out from the shot blasting equipment 30 to the motor-operated carriage 21 of the traverser 20, first the motor-operated carriage 21 is moved to the exit-side roller conveyor 35 as shown in FIG. 4 also. Then, the exit-side door 33 is opened to place the pallet 1 along with the tray 3 from the exit-side roller conveyor 35 on the motor-operated carriage 21.

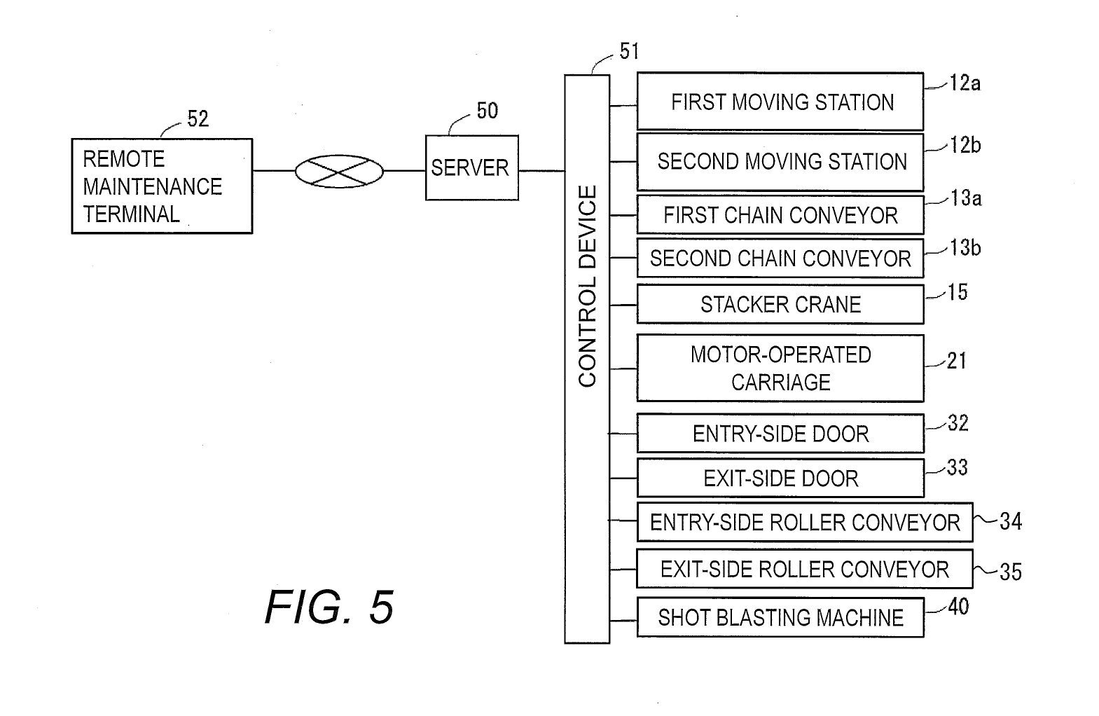

FIG. 5 is an electric configuration diagram of the shot blasting system. In the shot blasting system, a control device 51 is connected to a server 50, and to the control device 51 are connected various types of sensors (not shown) and the devices such as the automatic warehouse 10 including the first moving station 12a and the second moving station 12b, the traverser 20, and the shot blasting equipment 30. To the server 50, a remote maintenance terminal 52 is connected via a communication network.

The server 50 controls and manages the shot blasting system as a whole and is utilized also as a terminal to set control information etc. of the shot blasting system. The pallet 1 in the automatic warehouse 10 is also managed by the server 50. Specifically, unique addresses are assigned to the shelves of the first rack 11a and the second rack 11b, respectively. Based on this, the pallets 1 are controlled in the shot blasting system.

The control device 51 is made up of a plurality of programmable logic controllers (PLCs) and, in response to commands received from the server 50, controls the devices such as the first moving station 12a and the second moving station 12b and receives information from the various sensors (not shown). The remote maintenance terminal 52 is set up at a location where it can always be monitored and where the shot blasting system is not set up, thereby monitoring troubles etc. on the shot blasting system.

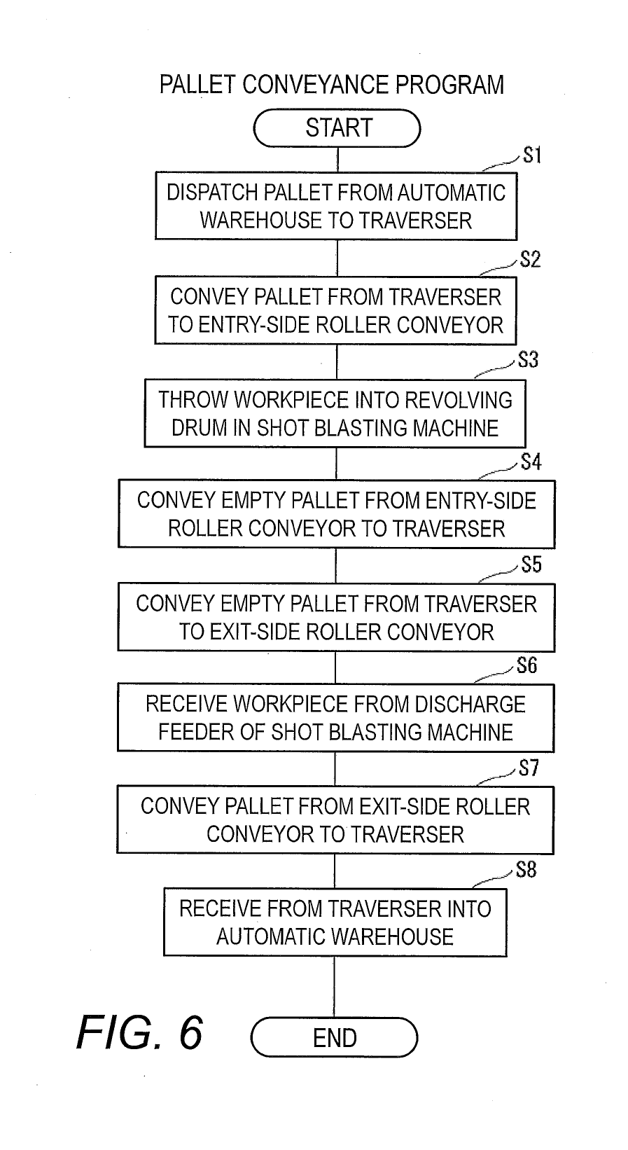

A description will be given of a method of controlling the shot blasting system having mechanical and electrical configuration described above in a condition where the workpieces W in the predetermined pallet 1 undergo shot blasting and then are housed in the automatic warehouse 10, with reference to FIGS. 6 to 10.

When a command is received from the server 50, a pallet conveyance program in FIG. 6 is executed. First, in step S1 in the pallet conveyance program, the pallet 1 is taken out from a predetermined shelf of the first rack 11a (second rack lib) by the stacker crane 15 and placed on the end of the first chain conveyor 13a (second chain conveyor 13b) on the side of the first rack 11a (second rack 11b). At this time, the pallet 1 is placed on the tray 3 that is on the first chain conveyor 13a (second chain conveyor 13b). Then, the pallet 1 is transported along with the tray 3 to the end of the first chain conveyor 13a (second chain conveyor 13b) on the side of the traverser 20 and placed on the motor-operated carriage 21 from the first chain conveyor 13a (second chain conveyor 13b). Accordingly, the pallet 1 is dispatched from the automatic warehouse 10 to the traverser 20. Step S1 is a “dispatching step”.

In step S2, the motor-operated carriage 21 is moved to the position of the entry-side roller conveyor 34, to open the entry-side door 32. Then, the pallet 1 is placed on the entry-side roller conveyor 34 along with the tray 3 from the motor-operated carriage 21. Accordingly, the pallet 1 is carried in the shot blasting equipment 30 from the motor-operated carriage 21. Step S2 is a “carrying in step”.

In step S3, the pallet 1 is transported along with the tray 3 by the entry-side roller conveyor 34 and placed on the bucket of the bucket loader 41. Then, the pallet 1 is elevated to the position of a carrying in door of the revolving drum 42 by the bucket loader 41 and then tilted. Accordingly, the workpieces W are thrown from the pallet 1 into the revolving drum 42. Step S3 is a “workpiece throwing step”.

In step S4, the pallet 1 is returned to a horizontal posture and unloaded by the bucket loader 41. Then, the pallet 1 is placed on the entry-side roller conveyor 34 along with the tray 3 from the bucket of the bucket loader 41 to be transported. Then, the entry-side door 32 is opened to place the pallet 1 along with the tray 3 on the motor-operated carriage 21 from the entry-side roller conveyor 34.

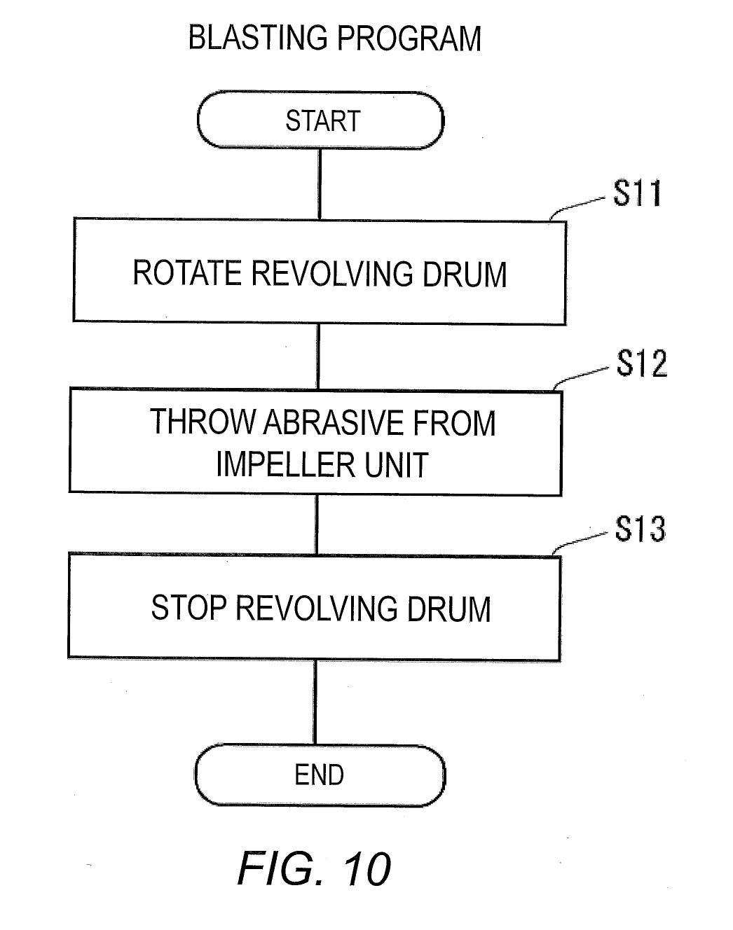

In step S5, the motor-operated carriage 21 is moved to the position of the exit-side roller conveyor 35, to open the exit-side door 33. Then, the pallet 1 is placed on the exit-side roller conveyor 35 along with the tray 3 from the motor-operated carriage 21. Steps S4 and S5 make up a “pallet forwarding step”. In the pallet forwarding step, a blasting program (see FIG. 10) to be described later is executed concurrently.

In step S6, the pallet 1 is transported along with the tray 3 by the exit-side roller conveyor 35 and placed on the tilting device 47. Then, the workpieces W are thrown from the discharge feeder 46 into the pallet 1 as the pallet 1 undergoes the combination of tilting and advancing a plurality of number of times by the tilting device 47. The workpieces W have already undergone blasting. Step S6 is a “workpiece discharging step”.

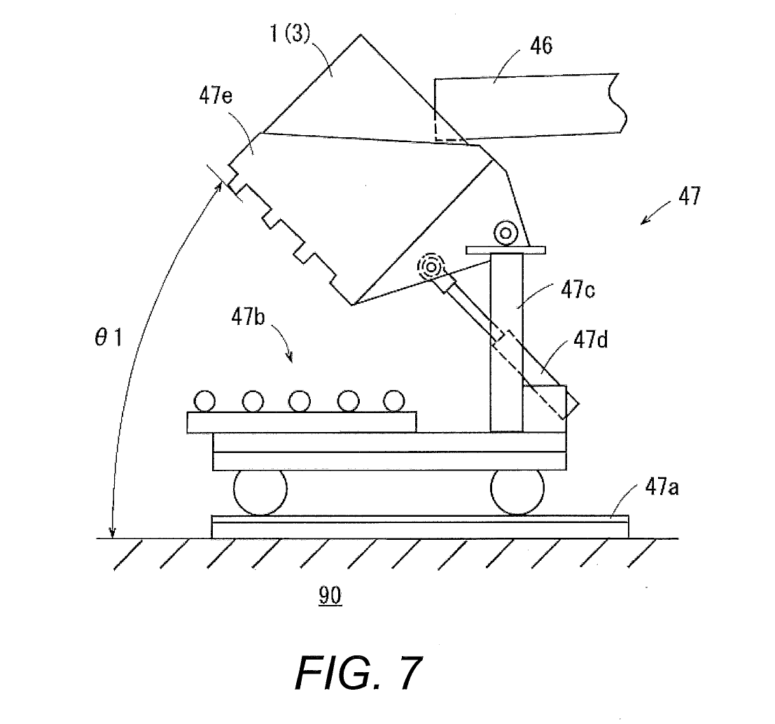

The following will describe in detail a step of the workpieces W being thrown from the discharge feeder 46 into the pallet 1 with reference to FIGS. 7 to 9. As shown in FIG. 7, the tilting device 47 has a rail 47a, a carriage 47b, a support pillar 47c, a cylinder 47d, and a bucket 47e. The rail 47a is fixed to a floor 90, and the carriage 47b can move back and forth (right-and-left direction in the figure) on this rail 47a. The support pillar 47c erects on the front portion of the carriage 47b, and the bucket 47e is provided on the top of the support pillar 47c. The bucket 47e is configured to place the pallet 1 and the tray 3 thereon and be swingable by the cylinder 47d around the top of the support pillar 47c.

When the pallet 1 is placed on the bucket 47e of the tilting device 47 along with the tray 3, the rod of the cylinder 47d moves ahead, so that the bucket 47e rotates (turns right in the figure) around the top of the support pillar 47c, as shown in FIG. 7. Accordingly, the pallet 1 (tray 3) is tilted to have an angle of θ1 (45°) formed between the floor 90 and the pallet 1. Then, the workpieces W are thrown by the discharge feeder 46 into the pallet 1. At this time, the carriage 47b is at the rear (on the left side in the figure) of the rail 47a, so that the workpieces W discharged by the discharge feeder 46 are concentrated in the front side (right side in the figure) of the pallet 1 to be housed.

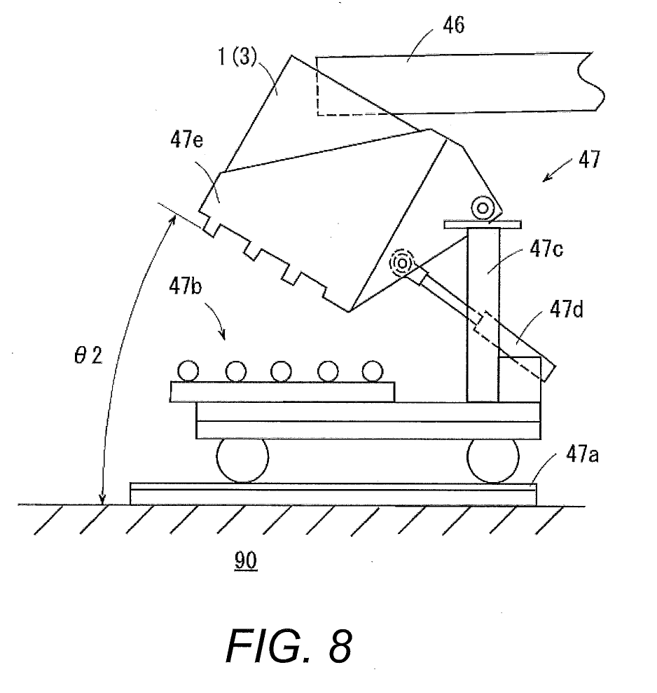

After a predetermined lapse of time, the rod of the cylinder 47d moves backward, so that the bucket 47e rotates (turns left in the figure) around the top of the support pillar 47c, as shown in FIG. 8. Accordingly, the pallet 1 (tray 3) is tilted to have an angle of θ2 (30°) formed between the floor 90 and the pallet 1. Then, the carriage 47b is moved to the front (right side in the figure) of the rail 47a. At this time, since the carriage 47b is at the front (on the right side in the figure) of the rail 47a, the workpieces W discharged by the discharge feeder 46 are concentrated in the rear side (left side in the figure) of the pallet 1 to be housed. By throwing the workpieces W into the pallet 1 as moving the carriage 47b in such a manner, the workpieces W can be easily housed in the pallet 1 evenly and uniformly.

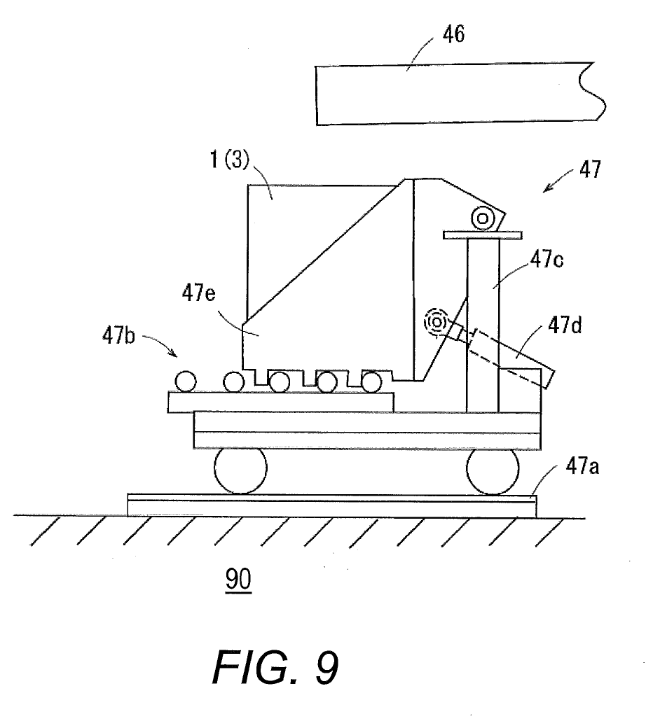

After a further predetermined lapse of time, the rod of the cylinder 47d moves backward in three phases. Accordingly, the pallet 1 (tray 3) is kept at constant angles (22°, 15°, and 8°) with respect to the floor 90 in three phases for a predetermined lapse of time. Finally, as shown in FIG. 9, the rod of the cylinder 47d moves backward to the rearmost end to place the bucket 47e on the carriage 47b. By thus reducing stepwise the angle formed between the floor 90 and the pallet 1 as the number of the remaining workpieces W decreases, it is possible to reduce the workpieces W to be damaged.

In step S7, the pallet 1 is placed on the exit-side roller conveyor 35 with a tray 3 from the tilting device 47 to be transported. Then, the exit-side door 33 is opened and the pallet 1 along with the tray 3 is placed on the motor-operated carriage 21 from the exit-side roller conveyor 35. Step S7 is a “carrying out step”. The exit-side door 33 is fitted with an angle (not shown) at the front upper portion thereof, to even the workpieces W in the pallet 1 when the pallet 1 is being carried out of the exit-side door 33. That is, when some of the workpieces W bulge from the pallet 1, bulged workpieces W are dropped into the pallet 1 by the angle. Consequently, it is possible to prevent the workpieces W from falling down from the pallet 1 and also, when the pallet 1 is housed on a predetermined shelf of the first rack 11a (second rack 11b) in the automatic warehouse 10, to prevent the workpieces W from coming in contact with the top of the shelf.

In step S8, first the motor-operated carriage 21 is moved to the position of the first chain conveyor 13a (second chain conveyor 13b). Then, the pallet 1 is placed along with the tray 3 on the first chain conveyor 13a (second chain conveyor 13b) from the motor-operated carriage 21 and transported over the first chain conveyor 13a (second chain conveyor 13b). Then, the pallet 1 is separated from the tray 3 by the stacker crane 15 and housed on the predetermined shelf of the first rack 11a (second rack 11b). In such a manner, the pallet 1 is housed in the automatic warehouse 10. Step S8 is a “receiving step”.

Next, a description will be given of a blasting program shown in FIG. 10. As described above, the blasting program will be executed concurrently with the pallet forwarding step in the pallet conveyance program.

When execution of the blasting program starts, the revolving drum 42 of the shot blasting machine 40 revolves in step S11. In step S12, the abrasive is thrown from the impeller unit 43. Accordingly, scale and burrs are removed from the workpieces W. After a predetermined lapse of time, the revolving drum 42 stops revolving in step S13. The predetermined lapse of time is timer-controlled by the server 50 based on a unique address assigned to each of the shelves of the first rack 11a and the second rack 11b. Further, the predetermined lapse of time is set in accordance with the shape of the workpieces W and whether they have undergone heat treatment or not. For example, when the workpieces W have undergone heat treatment, scale sticks to them more than the workpieces W without heat treatment, so that the predetermined lapse of time is elongated. The thrown abrasive is recovered by the shot circulator 44 and circulated to the impeller unit 43 to be utilized again. Dust such as the scale removed from the workpieces W is sucked in by the dust collector 45. Steps S11, S12, and S13 make up a “blasting step”.

The shot blasting system and the method of controlling the same according to the embodiment includes the automatic warehouse 10 that can receive and dispatch the pallet 1 in which the workpieces W are housed by using the stacker crane 15, the shot blasting equipment 30 that performs shot blasting on the workpieces W, and the traverser 20 that can convey the pallet 1 between the automatic warehouse 10 and the shot blasting equipment 30. In the dispatching step (step S1) and the receiving step (step S8), the pallet 1 (workpieces W) before and after blasting is managed. In the blasting step (steps S11, S12, and S13), the abrasive is struck to the workpieces W to perform blasting. In the dispatching step (step S1), the carrying in step (step S2), the carrying-out step (step S7), and the receiving step (step S8), the pallet 1 (workpieces W) is conveyed. Therefore, according to the shot blasting system and the method of controlling the same of the embodiment, management, shot blasting, and conveyance of the workpieces can all be consolidated and automated, to operate the system in an unmanned manner.

Since the shot blasting system includes the sound barrier 31 provided with the entry-side door 32 and the exit-side door 33, the entry-side door 32 and the exit-side door 33 can be opened for carrying in or out the workpiece W and closed for sealing the shot blasting equipment 30 for working in the shot blasting equipment 30. Accordingly, it is possible to prevent work noise from leading out of the shot blasting equipment 30. Therefore, the shot blasting system can be operated even at night.

Further, in the shot blasting system, the pallet 1 is configured to be placed on the tray 3 and separated from the tray 3. Accordingly, in the automatic warehouse 10 housing a great number of the pallets 1, the pallets 1 can be separated from the tray 3 to be handled independently, while in the shot blasting equipment 30 and the traverser 20 having a less number of the pallets 1, the pallets 1 can be placed on the tray 3 to be handled with the tray 3. Consequently, it is possible to reduce the number of the trays 3 required, thereby reducing costs of manufacturing the system as a whole.

Further, in the shot blasting system, a rectangular parallelepiped block 3a erects at each of the four corners of the tray 3, so that it is possible to shorten the legs 1a of the pallet 1 by placing the legs 1a of the pallet 1 on these blocks 3a, thereby reducing time for disposing goods in the automatic warehouse 10 and to reduce possibilities of the pallet 1 being hooked by the tray 3.

Moreover, in the shot blasting system, the L-shaped sectional guide plate 3b with the tip extending outward erects on each of the two external side surfaces of each of the blocks 3a of the tray 3 in close contact with the block, so that the pallet 1 can be easily placed on the tray 3 stably.

Further, by the method of controlling the shot blasting system, when the workpieces W are discharged from the discharge feeder 46 in the workpiece W discharging step by performing the combination of tilting and advancing of the pallet 1a plurality of number of times, so that it is possible to easily house the workpieces W evenly and uniformly in the pallet 1 and also it is possible to reduce the workpieces W to be damaged.

Although the method of controlling the shot blasting system of the embodiment has been described with reference to the handling of one pallet 1, it is possible to perform the workpiece discharging step (step S6) on one pallet 1 while simultaneously performing the dispatching step (step S1) through the carrying in step (step S2) on another pallet 1. That is, two pallets 1 can be handled simultaneously, so that the shot blasting system can be operated efficiently.

Further, it is also possible to extend the track 22 of the traverser 20 to add one or a plurality of the shot blasting equipments 30, thereby enhancing the operation efficiency of the system as a whole.

Although the shot blasting system and the method of controlling the same have been described with reference to the embodiment, of course, the present invention is not limited to this and can be changed and applied appropriately as far as it does not depart from the technological gist of the invention.

A shot blasting system according to a first aspect of the embodiment includes an automatic warehouse configured to receive and dispatch a pallet with a workpiece housed therein by using a stacker crane, a shot blasting equipment performing shot blasting on the workpiece, and a traverser configured to convey the pallet between the automatic warehouse and the shot blasting equipment.

In the shot blasting system according to a second aspect of the embodiment, the shot blasting equipment includes a sound barrier provided with an automatic door through which the workpiece is carried in and out of the shot blasting equipment.

In the shot blasting system according to a third aspect of the embodiment, in the shot blasting equipment and the traverser, the pallet is placed on a tray to be conveyed; the pallet has a rectangular parallelepiped shape with 12 sides formed with a metal rod, four side surfaces and a bottom surface covered by a metal mesh, an upper surface opened to take in and out the workpiece, and a rod-shaped leg projecting downward provided at each of four corners of the bottom surface; and the tray has a square shape with four sides formed with a metal plate, a rectangular parallelepiped block erecting at each of four corners of the tray, an L-shaped sectional guide plate with a tip extending outward erecting on each of two external side surfaces of each of the blocks in close contact with the block.

In the shot blasting system according to a fourth aspect of the embodiment, the workpiece is a hot forged product.

A method of controlling a shot blasting system according to a fifth aspect of the embodiment includes: a dispatching step of dispatching a pallet with a workpiece housed from a predetermined rack and conveying the pallet to a motor-operated carriage of a traverser by using a stacker crane; a carrying in step of conveying the pallet to an entrance-side roller conveyor of a shot blasting equipment by using the motor-operated carriage; a workpiece throwing step of throwing the workpiece from the pallet on the entry-side roller conveyor into a revolving drum; a pallet forwarding step of conveying the pallet from the entry-side roller conveyor to an exit-side roller conveyor by using the motor-operated carriage; a blasting step of performing blasting by striking an abrasive to the workpiece in the revolving drum; a workpiece discharging step of discharging the post-blasting workpiece from the revolving drum to the pallet via a discharge feeder; a carrying out step of conveying the pallet from the exit-side roller conveyor to the motor-operated carriage; and a receiving step of conveying the pallet to the stacker crane to house the pallet onto the predetermined rack by using the motor-operated carriage.

In the method according to a sixth aspect of the embodiment, in the workpiece discharging step, the workpiece is discharged from the discharge feeder by performing a combination of tilting and advancing of the pallet a plurality of number of times.

In the method according to a seventh aspect of the embodiment, the workpiece is a hot forged product.

A shot blasting system according to the first aspect includes an automatic warehouse configured to receive and dispatch a pallet with a workpiece housed therein by using a stacker crane, a shot blasting equipment performing shot blasting on the workpiece, and a traverser configured to convey the pallet between the automatic warehouse and the shot blasting equipment. Accordingly, it is possible to manage the workpiece in the automatic warehouse, perform shot blasting by using the shot blasting equipment, and convey the workpiece between the automatic warehouse and the shot blasting equipment by using the traverser, thereby consolidating and automating all of management, shot blasting, and conveyance of the workpiece. Therefore, the shot blasting system can be operated in an unmanned manner.

A shot blasting system according to the second aspect includes a sound barrier provided with an automatic door, so that the automatic door can be opened for carrying in or out the workpiece and closed for sealing the shot blasting equipment in operating therein. Accordingly, it is possible to prevent operation noise from leaking out of the shot blasting equipment. Therefore, the shot blasting system can be operated even at night.

In a shot blasting system according to the third aspect, the pallet is configured to be placed on a tray and separated from the tray. Accordingly, in the automatic warehouse receiving a lot of the pallets, the pallets and the trays can be separately handled from each other, while in the shot blasting equipment and the traverser conveying a small number of the pallets, the pallets can be handled with the tray. Consequently, it is possible to reduce the number of the trays required, thereby reducing costs of manufacturing the system as a whole.

Further, a rectangular parallelepiped block erects at each of four corners of the tray, so that it is possible to place the leg of the pallet thereon, and to shorten the pallet legs, thereby reducing time for disposing goods in the automatic warehouse and reducing possibilities of the pallet being hooked by the tray.

Moreover, an L-shaped sectional guide plate with a tip extending outward erects on each of two external side surfaces of each of the blocks on the tray in close contact with the block, so that the pallet can be easily placed on the tray stably.

The shot blasting system according to the fourth aspect is configured to handle a hot forged workpiece and be operated in an unmanned manner.

In a method of controlling a shot blasting system according to the fifth aspect, in a dispatching step and a receiving step, a workpiece is managed before and after blasting. In a blasting step, blasting is performed by striking an abrasive to the workpiece. Further, in the steps of dispatching, carrying in, carrying out, and receiving, the workpiece is conveyed. Therefore, according to the method of controlling a shot blasting system, management, shot blasting, and conveyance of the workpiece can all be consolidated and automated, to operate the system in an unmanned manner.

In the method of controlling the shot blasting system according to the sixth aspect, workpieces are discharged from the discharge feeder in the workpiece discharging step by performing a combination of tilting and advancing of the pallet a plurality of number of times, so that it is possible to easily house the workpieces evenly and uniformly in the pallet and also avoid damaging the pallet.

In the method of controlling the shot blasting system according to the seventh aspect, a system is configured to handle a hot forged workpiece and be operated in an unmanned manner.

Obviously, numerous modifications and variations of the present invention are possible in light of the above teachings. It is therefore to be understood that within the scope of the appended claims, the invention may be practiced otherwise than as specifically described herein.

What is claimed is:

1. A shot blasting system comprising:
an automatic warehouse configured to receive and dispatch a pallet with a workpiece housed therein by using a stacker crane;
a shot blasting equipment to perform shot blasting on the workpiece; and
a traverser configured to convey the pallet between the automatic warehouse and the shot blasting equipment.

2. The shot blasting system according to claim 1, wherein the shot blasting equipment includes a sound barrier provided with an automatic door through which the workpiece is carried in and out of the shot blasting equipment.

3. The shot blasting system according to claim 1, wherein:
in the shot blasting equipment and the traverser, the pallet is placed on a tray to be conveyed;
the pallet has a rectangular parallelepiped shape with 12 sides formed with a metal rod, four side surfaces and a bottom surface covered by a metal mesh, an upper surface opened to take in and out the workpiece, and a rod-shaped leg projecting downward provided at each of four corners of the bottom surface; and
the tray has a square shape with four sides formed with a metal plate, a rectangular parallelepiped block erecting at each of four corners of the tray, and an L-shaped sectional guide plate with a tip extending outward erecting on each of two external side surfaces of each of the blocks in close contact with the block.

4. The shot blasting system according to claim 1, wherein the workpiece is a hot forged product.

5. A method of controlling a shot blasting system comprising:
a dispatching step of dispatching a pallet with a workpiece housed from a predetermined rack and conveying the pallet to an electric carriage of a traverser by using a stacker crane;
a carrying in step of conveying the pallet to an entrance-side roller conveyor of a shot blasting equipment by using the motor-operated carriage;
a workpiece throwing step of throwing the workpiece from the pallet on the entry-side roller conveyor into a revolving drum;
a pallet forwarding step of conveying the pallet from the entry-side roller conveyor to an exit-side roller conveyor by using the motor-operated carriage;
a blasting step of performing blasting by striking an abrasive to the workpiece in the revolving drum;
a workpiece discharging step of discharging the post-blasting workpiece from the revolving drum to the pallet via a discharge feeder;
a carrying out step of conveying the pallet from the exit-side roller conveyor to the motor-operated carriage; and
a receiving step of conveying the pallet to the stacker crane to house the pallet onto the predetermined rack by using the motor-operated carriage.

6. The method according to claim 5, wherein in the workpiece discharging step, the workpiece is discharged from the discharge feeder by performing a combination of tilting and advancing of the pallet a plurality of number of times.

7. The method according to claim 5, wherein the workpiece is a hot forged product.
